(19) United States
(12) Patent Application Publication
(10) Pub. No.: US 2013/0177887 A1
(43) Pub. Date: Jul. 11, 2013

(54) Simulator and a Method for Simulating the Treatment of a Biological Tissue

(71) Applicant: Jens Hoehne, Munich (DE)

(72) Inventor: Jens Hoehne, Munich (DE)

(21) Appl. No.: 13/531,722

(22) Filed: Jun. 25, 2012

(30) Foreign Application Priority Data
Jan. 21, 2010 (DE) 102010001084.7
Jan. 19, 2011 (EP) PCT/EP2011/050709

(51) Int. Cl. G09B 23/28

(52) U.S. Cl. CPC G09B 23/283
USPC 434/263; 434/267

(57) ABSTRACT

A simulator for simulating treatment of biological tissue comprises a real handle with three degrees of freedom of both translation and rotation, a screen for displaying a model of the treatment area and a virtual handle, a motion detection device for detecting the three-dimensional motion of the real handle, and a computer having a simulation program that displays the virtual handle on the screen in spatial relation to the biological tissue on the basis of the motion of the real handle detected by the motion detection device. The real handle simulates a laser head that emits a laser beam for treating the biological tissue. The simulation program calculates an impinging surface of the laser beam on the biological tissue based on the spatial relation and laser parameters and calculates an energy density distribution of the laser beam within the impinging surface. The removal of tissue is displayed on the screen.

### CROSS REFERENCE TO RELATED APPLICATION

This application is filed under 35 U.S.C. §111(a) and is based on and hereby claims priority under 35 U.S.C. §120 and §365(c) from International Application No. PCT/EP2011/050709, filed on Jan. 19, 2011, and published as WO 2011/089164 A2 on Jul. 28, 2011, which in turn claims priority from German Application No. 102010001084.7, filed on Jan. 21, 2010, in Germany. This application is a continuation-in-part of International Application No. PCT/EP2011/050709, which is a continuation of German Application No. 102010001084.7. International Application No. PCT/EP2011/050709 is pending as of the filing date of this application, and the United States is an elected state in International Application No. PCT/EP2011/050709. This application claims the benefit under 35 U.S.C. §119 from German Application No. 102010001084.7. The disclosure of each of the foregoing documents is incorporated herein by reference.

### TECHNICAL FIELD

The present invention relates to a simulator apparatus and to a method for simulating the treatment of a biological tissue. The present invention relates particularly to a simulator and to a method for simulating a dental treatment.

### BACKGROUND

In many areas of science, a manually performed movement of a handle having degrees of freedom of translation and rotation is converted mechanically or electromechanically into the motion of a tool that corresponds to the manually performed motion. This conversion can occur, for example, via an appropriate step-up or servo transmission, wherein the handle can be designed as a pinch grip and the tool as a gripper. Such auxiliary materials are used, for example, in laboratories for handling hazardous materials. The operator performs a gripping motion on the pinch grip, but the object to be gripped is conducted by a remote gripper that follows the motions of the operator's hand. If the “image space” (the space in which the tool is located) is only virtual and represented on a computer screen, then the operation is not carried out in reality but is only simulated. The present invention discloses an apparatus that can perform such a simulation. The virtual image space represented on the computer screen depicts the tool and also the environment in which the tool is embedded in spatial relation to the “workpiece” or objects operated upon. The image space is thus a copy of the object space to the extent that the tool and the workpiece move in an equivalent spatial relation to each other in the image space. According to the present invention, the “workpiece” in the above general introduction is human tissue, and the simulator is used by an operator to learn to perform medical interventions.

In dental medicine, in the treatment of a carious tooth, the disclosed simulation apparatus can be used in a cost efficient manner to practice handling a drill or the like as many times as desired and to experience the forces that occur in the process, without consuming material. In general, real patient data obtained using computer tomography or magnetic resonance tomography can be used as a foundation for simulating the biological tissue.

An object of the present invention is to provide a simulator that can be used to simulate a treatment of a biological tissue (the “workpiece” in the sense of the general introduction above). An additional object of the invention is to provide a method for simulating a treatment of a biological tissue.

### SUMMARY

A simulator apparatus includes a real handle, a motion detection device, a computer and a screen. An operator of the simulator apparatus can move the real handle in three degrees of freedom of rotation and in three degrees of freedom of translation. The motion detection device detects the rotation and translation of the real handle. A simulation program executes on the computer and displays a virtual handle and a three-dimensional model of a simulated biological tissue on the screen. The simulation program receives a laser parameter and a tissue parameter input by the operator. The simulation program depicts the virtual handle emitting a simulated laser beam such that the virtual handle moves on the screen in a spatial relation to the simulated biological tissue based on the rotation and translation of the real handle. On the basis of the spatial relation and of the laser parameter, the simulation program indicates a surface on the simulated biological tissue that would be irradiated by the simulated laser beam. The laser parameter is a wavelength, a power, a type of laser beam, or an angle between the longitudinal axis of the virtual handle and the irradiated surface of the simulated biological tissue. The tissue parameter is a material composition, hardness, a color, a spectral reflectance or a surface roughness.

The simulation program determines an energy density distribution within the irradiated surface. Based on the energy density and on the tissue parameter, the simulation program displays the simulated biological tissue being removed by the simulated laser beam. The simulation program also displays a cross-sectional view of how the simulated biological tissue is removed by the simulated laser beam.

A method for simulating a medical procedure displays how a simulated biological tissue is removed by a simulated laser beam emitted from a virtual handle whose movement corresponds to the movements of a real handle manipulated by an operator. The method involves detecting the movement of the real handle and displaying the virtual handle and a three-dimensional model of a treatment area of the simulated biological tissue on a screen. For example, the simulated biological tissue is dental tissue. The virtual handle moves on the screen in a spatial relation to the simulated biological tissue based on the movement of the real handle. A simulation program receives a laser parameter and a tissue parameter input by the operator. The simulation program simulates a laser beam being emitted from the virtual handle. On the basis of the spatial relation and of the laser parameter, the simulation program determines the surface of the simulated biological tissue that would be irradiated by the laser beam and an energy density distribution within the irradiated surface. The method displays the simulated biological tissue being removed by the laser beam based on the energy density and the tissue parameter. Any unwanted contact between the virtual handle and the simulated biological tissue is signaled to the operator on the screen or acoustically.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic diagram of a preferred embodiment of the present invention in which a virtual handle and simulated biological tissue are depicted in three dimensions on the screen of a simulator apparatus.

FIG. 2 is a schematic diagram of an embodiment in which the virtual handle and the simulated biological tissue are depicted in two dimensions on the screen of the simulator apparatus.

### DETAILED DESCRIPTION

Reference will now be made in detail to some embodiments of the invention, examples of which are illustrated in the accompanying drawings.

A real handle simulates a laser head that emits a laser beam of a laser for treating a biological tissue without contact. The real handle, particularly its movements that are detected by a motion detection device, are displayed in real time on a screen of a computer in a spatial relation to the biological tissue. In the process, the biological tissue can be displayed either virtually, i.e., on the computer screen, or also true to scale as a real model. In the first case, the concentration of a user/operator is directed entirely on the virtual world represented on the screen. In the second case, the operator can observe the movements performed both in the real and also in the virtual world that are helpful for learning to operate the simulator. In operating the simulator, the first case of observing the virtual world can be considered the second step. In both cases, the real handle behaves like the cursor of a computer mouse, except that the 2-dimensional motion of the mouse is not displayed as a 2-dimensional motion on a screen, but rather a motion of the real handle having a 6-dimensional phase space with the coordinates x, y, z, α, β and γ in a correlating motion is imaged as a virtual 6-dimensional phase space with the coordinates x′, y′, z′, α′, β′ and γ′: (vₓ, v_{y}, v_{z}, ωₓ, ω_{y}, ω_{z})ᵣₑₐₗΔ(vₓ′, v_{y}′, v_{z}′, ωₓ′, ω_{y}′, ω_{z}′)ᵥᵢᵣₜᵤₐₗ, where vᵢ, vⱼ, ωₖ, ω₁′ with i, j, k, l ∈ {x, y, z} are the speeds in the object space, the speeds in the image space, the angular speeds in the object space (about the x, y and z axes) and the angular speeds in the image space (about the x′, y′ or z′ axes). “Correlating” here means that the virtual space is represented as a cavalier projection on the computer, and results in a translation motion of the real handle by Δx (Δy), a translation motion of the virtual handle by Δx′ (Δy′) where Δx=Δx′ and Δy=Δy′, wherein the screen plane is defined by x·êₓ and y^{SM}ê_{y} with the unit vectors êₓ and ê_{y}, and a translation motion of the real handle by Δz results in a translation motion of the virtual handle by Δz′ where Δz′=½Δz. The representation of the respective angles results from the coordinates of two points of the real handle and the virtual images thereof. Furthermore, the angles α (α′), β (β′) and γ (γ′) are the angles between a longitudinal axis of the handle and the x axis in the y, z plane, the y axis in the x, z plane, or the z axis in the x, y plane, and ωₓ, ω_{y}, ω_{z} are the associated angular speeds. Alternatively, instead of being “correlating,” the motion can be stretched by a factor, and thus the representation on the screen can be enlarged, to make the motion clearer, or it can be compressed, in which case the representation on the screen is thus reduced in size to provide a better overview over the operating area.

The simulator further comprises an input device for inputting into the computer laser parameters of the laser and tissue parameters of the simulated biological tissue. The laser parameters comprise the emission mode, which may be continuous or pulsed, the wavelength λ or the wavelength range Δλ of the laser beam, the power, and the divergence angle of the laser light emanating from the laser. The tissue parameters comprise the tissue type (for example, epithelial tissue, connective or supportive tissue, muscle tissue, nerve tissue, and hard and soft tooth tissue), the degree of reflection and absorption for the wavelength λ used, the surface moisture or wetting (for example, due to saliva), the hardness, and the heat conductivity which is important in regard to the transfer of the introduced energy to deeper lying tissue layers. The simulation program determines the optimal treatment duration Δt and the shortest treatment distance using these parameters. The simulation program furthermore calculates, on the basis of the spatial relation and the laser parameters, the surface of the simulated biological tissue that is irradiated by the laser beam and that energy density distribution within the irradiated surface. The surface area of the tissue that is irradiated increases as the distance from the handle increases and as the angle of incidence of the laser beam deviates from normal. The irradiated surface area has a complicated form, for example, in the case of the chewing surface of a molar or premolar.

The simulation program displays on the screen how the simulated tissue is removed on the basis of the energy density distribution and the tissue parameters. The removal of material (tissue) is represented in a 3-dimensional view in such a manner that only the instantaneously acquired surface structure is visible. Alternatively, the removal of tissue if represented in such a manner that the original shape of the biological tissue remains visible as a transparent shadow over the instantaneously acquired surface structure. Showing the transparent shadow of the original shape of the tissue offers the advantage that the locally ablated material quantity is visible, from which one can see very clearly to what “depth” in the tissue radiation has been administered. The same comments essentially apply when the simulation apparatus displays the ablated tissue in the screen in two dimensions, except that the ablated material quantity need not be represented in a transparent manner, which improves the clarity of the representation.

It should be noted that if the position of the handle is held constant during the treatment, the shape of a corridor and the energy density distribution naturally change due to the continuously occurring removal of material (tissue). As a result, the energy density can rapidly change locally and can rapidly rise above the permissible maximum. This must be taken into account particularly in treatments wherein the removal of material occurs substantially discontinuously in “larger” volume units, for example, by “chipping off” tooth parts. A discontinuous removal to be expected in a given treatment situation can be advantageously signaled to the operator ahead of time, so that the power of the laser beam can be reduced to obtain smaller ablations per unit of time. The simulator apparatus is constructed to resemble a “haptic system” in which the operator experiences a realistic mechanical feedback that corresponds to the simulated treatment situation and that facilitates the operator's controlled handling of the simulated medical instrument. The absence of a true mechanical feedback is compensated in the simulator apparatus at least partially by elements of an optic-acoustic control that contribute to an equivalent learning success. During the simulation, the circumstance that the laser beam is not visible in the real case is also taken into account. Even in the simulation case, only the effects of the laser beam on the biological tissue is represented.

The laser beam is emitted only during the actuation of a switch. The switch can be integrated in the real handle, or the switch can be designed as a foot switch. As a result, in the terminology used with a conventional dentist drill, the real handle can be “put down” in a simple manner that does not interfere with the concentration of the operator. The treatment can thus be interrupted to evaluate what has been achieved so far and to select an additional site of the biological tissue. The simulator emits an acoustic signal by means of a signal generator while the laser beam is being emitted, i.e., while the switch is actuated. In this manner, the operator user experiences feedback, which helps avoid an accidental emission.

The simulator apparatus determines the actuation time of the switch as well as consequently the treatment time. The treatment time is displayed on the screen and is based on the ablative effect achieved by the radiation. The treatment time is determined based on the given parameters of the biological tissue and of the laser beam as well as of the position of the laser beam with respect to the tissue. The simulator apparatus includes a treatment time setting device that sets the treatment duration Δt. The treatment time is started by a one-time brief actuation of the switch, and the emission of the laser beam is automatically interrupted after the treatment duration has elapsed. A renewed brief actuation of the switch produces a renewed emission of the laser beam for an additional treatment duration Δt. The treatment duration can be determined using treatment-specific tables, or the treatment duration can be based on the experience of the operator. The switch includes both a foot switch and also a manual switch integrated in the real handle. The foot switch and manual switch are series connected so that an unintentional emission of the laser beam due to accidental actuation of the manual switch is ruled out and can occur only if the foot switch and manual switch are actuated concurrently.

The simulation program detects the spatial relation between the virtual handle and the simulated biological tissue. The spatial relation includes various components, such as the spatial separation (a shortest distance) between the handle and the tissue, as well as the treatment distance between the exit site of the laser beam from the handle and the intersection of the laser beam axis with the surface of the biological tissue. The spatial separation and the treatment distance need not always be identical. In particular, the spatial separation depends on the shape of the handle and that of the biological tissue. Another component of the spatial relation is the angle between the longitudinal axis of the handle and the characteristic axis of the simulated biological tissue. If the biological tissue is a tooth, for example, then the characteristic axis is the longitudinal axis of the tooth that, if the tooth has one root, is the imaginary line from the center of the cutting edge or the chewing surface to the tip of the root. If the tooth has several roots, the characteristic axis extends from the center of the chewing surface to the center of the bifurcation or trifurcation. The simulator apparatus includes a viewing setting means that switches between two viewing perspectives or rotates between multiple viewing perspectives. The viewing setting means also sets the colors in which the longitudinal axis of the handle and the characteristic axis of the biological tissue are represented.

The simulation program displays the laser beam and the impinging surface. Because the shape of the irradiated surface and thus the area of the biological tissue on which the laser beam has an effect can usually not be estimated by a beginning operator, the preferably colored display of the irradiated surface offers the beginning operator an aid to develop a feeling for how the radiation is distributed. The colored display of the irradiated surface also assists the beginning operator to learn how to hold and position the handle in such a manner that only the surface area to be treated is irradiated. However, as mentioned above, the real laser beam and the real irradiated surface are not generally visible, at least not to the naked eye.

The laser used by the simulator apparatus is an Nd:YAG, Ho:YAG or Er:YAG laser, that is a neodymium, holmium or erbium doped yttrium-aluminum-garnet laser. The wavelengths of these lasers are 1024 nm, 2127 nm and 2940 nm. However, lasers with other wavelengths can also be used with the simulator apparatus. The type of laser used depends on the tissue to be treated, specifically its spectral absorption, wherein a higher absorption results in a shallower depth of penetration and thus a higher energy density in the penetrated tissue.

The simulator apparatus includes a signaling device for signaling an unwanted contact (minimum separation) between the virtual handle and the simulated biological tissue. The signaling device signals when the virtual handle enters into the minimum separation zone. If the separation between the actual handle and actual tissue is smaller than the minimum separation, there is a risk that the handle will come in contact with the tissue. This can occur particularly in situations in which an untrained operator is concentrating on the laser beam or on the irradiated surface of the biological tissue where the handle is relatively wide, resulting in lateral contact with the tissue.

In one embodiment, the motion of the real handle is blocked such that the virtual handle does not enter the minimum separation between the virtual handle and the simulated biological tissue. Moreover, the movement of the real handle can be restricted such that a translation motion of the real handle away from the biological tissue and/or an angular motion of the real handle (depending on its position) can occur only within a three-dimensional corridor around the biological tissue to be treated. This means that in the case of a tooth treatment, not only the tooth to be treated, but also its position in the oral cavity, is represented on the screen. This is important, because the oral cavity limits the freedom of movement of the handle in the treatment of a tooth or other dental tissue, such as gum tissue. The freedom of movement of the handle is even more restricted the deeper the position in the oral cavity of the tooth or tissue to be treated. Thus, the treatment of a posterior molar tooth requires a greater skill than the treatment of an incisor or cuspid.

The simulator apparatus can include a second real handle that is represented on the screen in a spatial relation to the biological tissue and to the first real handle. The simulator apparatus can also include additional motion detection devices for detecting the head motion of the patient and/or of the operator. The simulator apparatus can also include a specialized 3-dimensional visualization device, such as enhanced 3D computer graphics. These additional components make using the simulator apparatus more realistic. After any desired practice time with the simulator apparatus, the operator can add these additional components, individually or in combination. The representation of the moving head of the patient on the screen can occur in the simplest manner by having the simulated biological tissue undergo typical movements and be displayed only schematically on the screen. To increase the realism of the simulation, it is possible to display a head schematically with opened mouth on the screen. The operator thus learns to react to simulated reflex motions of a patient caused by pain. Finally, the detection of the head motion of the operator is used to represent the image space from the viewing angle of one or more operators.

A 3-dimensional image can be produced on the screen using 3D glasses in which the left eye and the right eye perceive different information, i.e., perspectives. This can be achieved by a different coloration (red and green) of the left and right lenses of the 3D glasses, or by filtering differently polarized light. The operators, particularly if several operators or assistants work together on the simulator apparatus, are provided with glasses that each correspond to an independent screen so that each operator views the simulated biological tissue from his own individual viewing angle. The screen can be integrated into each of the glasses. The operators are thus in a three-dimensional “cooperative virtual reality.” The simulator includes 3D glasses that can be switched between the various perspectives and that are intended for a supervisor who monitors the learning process of several users and who can assume the perspective of each of the users.

A method for simulating the treatment of a biological tissue using the simulator apparatus includes the step of moving in a six-dimensional phase space a real handle designed as a laser head. The motion of the real handle is displayed as the motion of a virtual handle in a virtual six-dimensional phase space. The motion of the virtual handle is represented in a spatial relation to simulated biological tissue on a screen of the simulator apparatus. The simulator apparatus simulates that irradiating of the biological tissue with a laser beam emitted by the laser head.

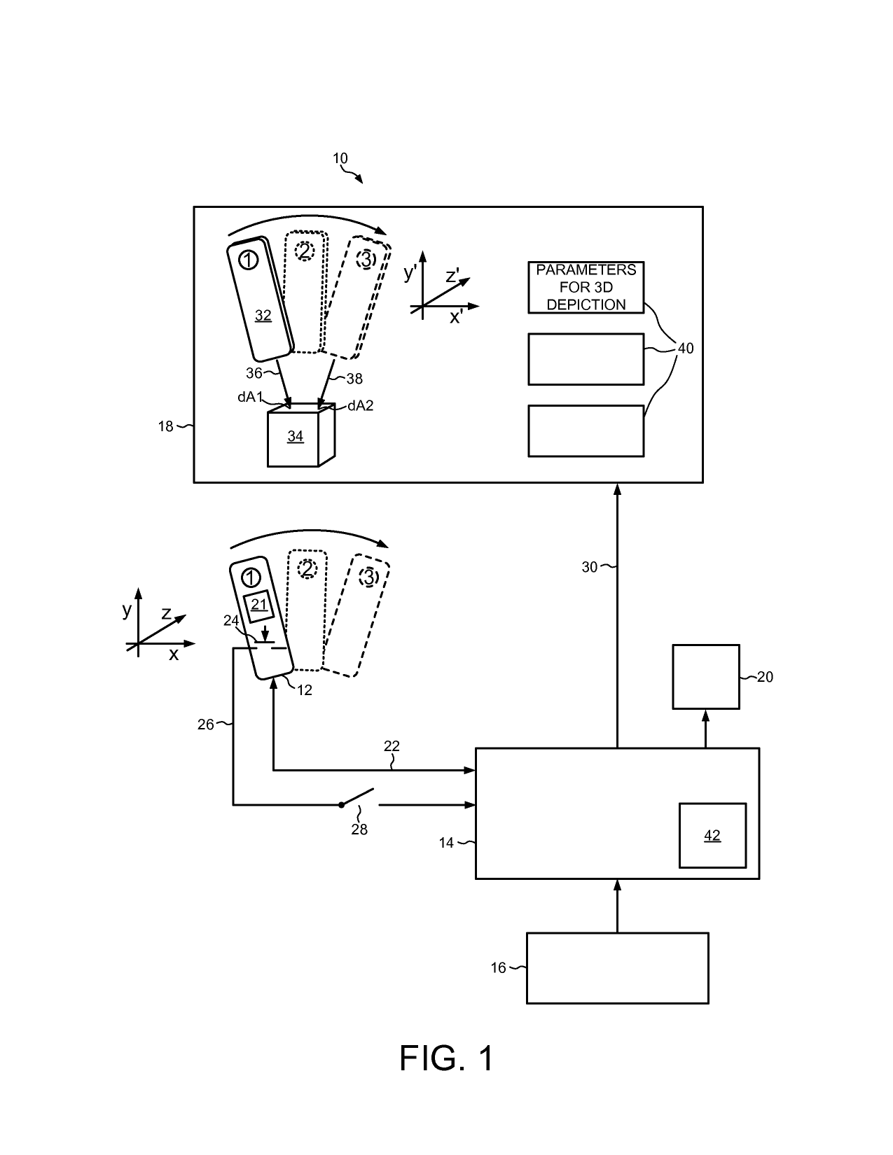

FIG. 1 shows a simulator apparatus 10 that includes a real handle 12, a computer 14, a keyboard 16, a screen 18 and a loudspeaker 20. Real handle 12 represents a laser head of a laser. The handle 12 is attached to computer 14 in such a manner that it can be moved at will by an operator of simulator apparatus 10 in an x, y, z object space (the viewing space). Thus, handle 12 exhibits three degrees of freedom {x, y, z} of translation and three degrees of freedom {ωₓ, ω_{y}, ω_{z}} of rotation about the axes x, y and z of the x, y, z object space. Handle 12 or its holder (not shown) is connected via a bidirectional data line 22 to the computer 14. On the one hand, motion data of the movement of handle 12 that is detected by a motion detection device 21 integrated into handle 12 is transmitted to computer 12 via data line 22. In one embodiment, motion detection device 21 includes three accelerometers oriented along each of the three axes x, y and z. On the other hand, data can be sent by computer 14 to the holder that blocks certain movements of handle 12 in predetermined situations. This means that the holder fulfills a passive function in which it allows movements of the handle 12 and an active function in which it prevents certain other movements. Handle 12 also includes a switch 24 that is connected via a line 26 to the computer 14. Moreover, a switch 28 that is connected in series to the switch 24 is located in the line 26. Both of switches 24 and 28 are required to close the electrical connection to handle 12, wherein the switch 24 is actuated by finger pressure, and the switch 28 is actuated by the operator's foot.

Screen 18 is connected via a line 30 to computer 14, and screen 18 is controlled by computer 14. An x′, y′, z′ image space is depicted on screen 18 in which a virtual handle 32 identical in size and shape to real handle 12 is displayed in a spatial relation to a biological tissue 34 to be treated. From motion data received from real handle 12, computer 14 generates motion data for virtual handle 32. Virtual handle 32 follows the movement of real handle 12 in real time. Computer 14 thus generates a representation (vₓ, v_{y}, v_{z}, ωₓ, ω_{y}, ω_{z})ᵣₑₐₗ [symbol] (vₓ′, v_{y}′, v_{z}′, ωₓ′, ω_{y}′, ω_{z}′)ᵥᵢᵣₜᵤₐₗ of the real object space in the virtual image space on screen 18. The corresponding movements of real handle 12 and virtual handle 32 are represented diagrammatically in FIG. 1 in such a manner that as handle 12 is moved from a starting position \textcircled{1} to an end position \textcircled{3}, these movements are shown in the image space on screen 18.

In FIG. 1, the arrows 36 and 38 indicate the laser beams in the starting position \textcircled{1} and in the end position \textcircled{3} on screen 18. In the intermediate position \textcircled{2} no arrow is shown to indicate that the laser beam can be switched off after the treatment of a first surface element dA1 and switched on again after moving the laser head 12, 32 to position \textcircled{3} for the treatment of a second surface element dA2. For example, the first and second surface elements dA1 and dA2 are different surfaces on a tooth. The laser head 12, 32 emits a laser beam only for a treatment duration Δt while both the switch 24 on real handle 12 as well as foot switch 28 are actuated. In particular, switch 28 is used to prevent an unwanted emission of the laser beam. On screen 18, an arrow representing a laser beam is thus displayed only when the two switches 24 and 28 are actuated concurrently.

The arrows 36 and 38 representing the laser beam start at the exit site of the laser beam from the laser head at the lower end of virtual handle 32. The arrows 36 and 38 end on the surface elements dA1 and dA2. For the computer 14 to be able to correctly reproduce the position, the length and the direction of the arrows 36 and 38, a reference position for both real handle 12 and also for virtual handle 32 must be defined. The reference position is represented as an additional position on the screen 18.

Several windows 40 are also displayed on screen 18. Simulator apparatus 10 displays in the windows 40 the laser parameters and the tissue parameters that are entered via keyboard 16 or read back from a memory 42 of computer 14.

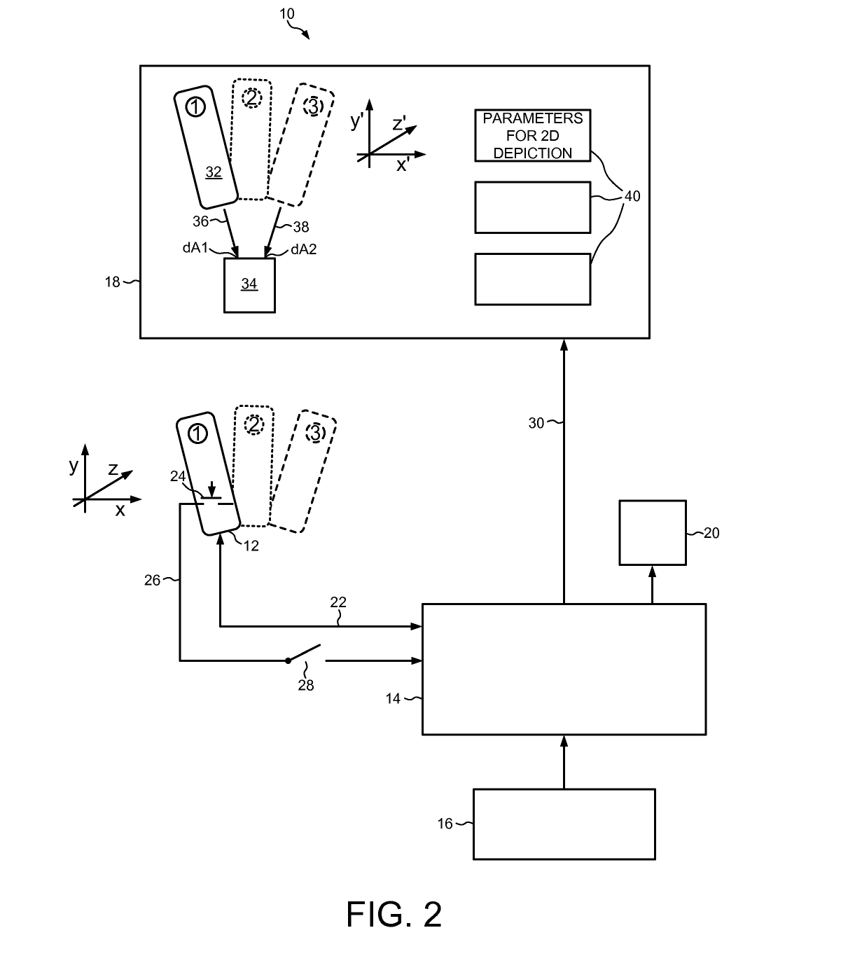

FIG. 1 shows a 3-dimensional depiction of virtual handle 32 and simulated biological tissue 34 on screen 18. The parameters and information corresponding to the 3-dimensional depiction are listed in the uppermost window of the windows 40. FIG. 2 shows a 2-dimensional depiction of virtual handle 32 and simulated biological tissue 34 on screen 18. The parameters and information corresponding to the 2-dimensional depiction are listed in the uppermost window of windows 40 in FIG. 2. Accordingly, additional views can also be represented, such as the above-described cross-sectional view of simulated biological tissue 34. The warning signals indicating that virtual handle 32 has entered the minimum allowable separation between virtual handle 32 and simulated biological tissue 34 can also be visually displayed on screen 18 or communicated acoustically through loudspeaker 20.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-19. (canceled)

20. An apparatus comprising:
a real handle that can be moved in three degrees of freedom of rotation and in three degrees of freedom of translation;
a motion detection device that detects the rotation and translation of the real handle;
a computer on which a simulation program executes, wherein the simulation program receives a laser parameter and a tissue parameter; and
a screen, wherein the simulation program displays a virtual handle and a three-dimensional model of a simulated biological tissue on the screen, wherein the virtual handle emits a simulated laser beam, wherein the virtual handle moves on the screen in a spatial relation to the simulated biological tissue based on the rotation and translation of the real handle, wherein the simulation program determines on the basis of the spatial relation and of the laser parameter a surface of the simulated biological tissue that would be irradiated by the simulated laser beam and an energy density distribution within the irradiated surface, and wherein based on the energy density and the tissue parameter the simulation program displays the simulated biological tissue being removed by the simulated laser beam.

21. The apparatus of claim 20, further comprising:
a switch, wherein the virtual handle emits the simulated laser beam only while the switch is actuated.

22. The apparatus of claim 21, further comprising:
a signal generator that emits an acoustic signal while the switch is actuated.

23. The apparatus of claim 21, further comprising:
a time detection device that detects a duration of time during which the switch is actuated.

24. The apparatus of claim 21, wherein the switch is integrated into the real handle.

25. The apparatus of claim 21, wherein the switch is a foot switch.

26. The apparatus of claim 20, wherein the three-dimensional model of the simulated biological tissue is displayed on the screen in a reduced or enlarged scale.

27. The apparatus of claim 20, wherein the simulation program displays a cross-sectional view of how the simulated biological tissue is removed by the simulated laser beam.

28. The apparatus of claim 20, wherein the laser parameter is taken from the group consisting of: a wavelength, a power, a divergence angle of laser light emitted from the virtual handle, an angle between a longitudinal axis of the virtual handle and the irradiated surface of the simulated biological tissue, and a type of laser beam.

29. The apparatus of claim 28, wherein the type of laser beam is a Nd:YAG laser, a Ho:YAG laser or a Er:YAG laser.

30. The apparatus of claim 20, wherein the tissue parameter is taken from the group consisting of: a material composition, a hardness, a color, a spectral reflectance and a surface roughness.

31. The apparatus of claim 20, wherein the simulated biological tissue is dental tissue.

32. The apparatus of claim 20, wherein the simulated biological tissue is gum tissue.

33. The apparatus of claim 20, wherein the simulation program signals an unwanted contact between the virtual handle and the simulated biological tissue.

34. The apparatus of claim 20, further comprising:
a blocking device that blocks the real handle from moving such that the virtual handle would encroach into a minimum separation from the simulated biological tissue.

35. The apparatus of claim 20, further comprising:
a second real handle, wherein the simulation program displays a second virtual handle on the screen, and wherein the second virtual handle moves on the screen based on a rotation and a translation of the second real handle.

36. The apparatus of claim 20, further comprising:
a second motion detection device that detects a head movement of an operator of the real handle.

37. A method comprising:
detecting movement of a real handle;
receiving a laser parameter and a tissue parameter;
displaying a virtual handle and a three-dimensional model of a treatment area of a simulated biological tissue on a screen, wherein the virtual handle moves on the screen in a spatial relation to the simulated biological tissue based on the movement of the real handle; simulating a laser beam emitted from the virtual handle;
determining on the basis of the spatial relation and of the laser parameter a surface of the simulated biological tissue that would be irradiated by the laser beam and an energy density distribution within the irradiated surface; and
displaying the simulated biological tissue being removed by the laser beam based on the energy density and the tissue parameter.

38. The method of claim 37, wherein the simulated biological tissue is dental tissue.

39. The method of claim 37, further comprising:
signaling an unwanted contact between the virtual handle and the simulated biological tissue.
